(19) United States
(12) Patent Application Publication
(10) Pub. No.: US 2011/0282501 A1
(43) Pub. Date: Nov. 17, 2011

(54) Method of detecting a liquid fuel leak in a gas turbine

(75) Inventor: Denis Martin, Vieux Charmont (FR)

(73) Assignee: GE Energy Products France SNC, Belfort (FR)

(21) Appl. No.: 12/961,116

(22) Filed: Dec. 6, 2010

(30) Foreign Application Priority Data
Dec. 7, 2009 (FR) 0958715

(51) Int. Cl. G06F 1/30

(52) U.S. Cl. 700/287

(57) ABSTRACT

The invention relates to a method of detecting the presence of a liquid fuel leak in a gas turbine (1). During this method:

a reference value (27, 37) is determined for at least a first operating parameter of the turbine,

a value (29, 39) of the said operating parameter is measured during a start-up phase of the turbine,

the measurement value and the reference value are compared,

whether a first anomaly (13, 41) is present is identified,

an alert notification (33, 43) is generated if a first anomaly (31, 41) is detected for the first parameter, and in parallel

shutdown of the turbine (35, 45) is triggered if a second anomaly (34, 44) is detected for a second parameter.

The invention also relates to a device for detecting a liquid fuel leak in a gas turbine, employing such a method.

The invention concerns the general field of electrical energy production machines comprising internal-combustion systems, and in particular gas turbines.

Conventionally, a gas turbine comprises an air intake duct, a compressor having one or more compression stages with an air flow rate regulation device, an internal-combustion system, an expansion turbine mechanically connected to the compressor, and a duct for discharging the exhaust gases. In order to set the gas turbine in operation, an activating motor is used which fulfils the function of a starter.

The various fluids necessary for operation of the turbine arrived through independent circuits. Distinction is made between the intake circuit for ambient air which can be compressed in the compressor, and a conduit of air for atomizing a liquid fuel after it has entered the combustion chamber, the fuel coming from a liquid fuel supply duct. More precisely, the atomization air comes from air extraction at the last stages of the compressor. It makes it possible to atomize the liquid fuel such as fuel oil into a mist of fine droplets, thus facilitating its combustion and efficiency, while avoiding the formation of smoke and emissions of carbon monoxide, which are the consequences of incomplete combustion or the presence of unburnt components.

During a start-up phase, however, that is to say after uncoupling the rotor of the activating motor and before coupling the alternator, before the full speed has been reached, there is significant opening of the blades which regulate the air flow rate of the compressor of the gas turbine. A sudden increase in the fuel oil flow rate may occur to its maximum allowed value, which is not however the maximum possible delivery rate of the fuel oil pump. This malfunction, moreover, is not always accompanied by an acceleration of the rotor of the turbine or an increase in the temperature of the exhaust gases.

Under these conditions, it is likely that some of the fuel oil coming from the liquid fuel supply duct will be sent elsewhere than into the combustion chamber, and particularly into the duct for air to atomize this fuel. The leaks may be caused, in particular, by a pressure difference between the combustion chamber and the atomization air circuit, or by a fault of the concentric passage injectors. This anomaly thus causes degraded operation due to a lack of fuel in the chamber, but without causing shutdown of the machine.

Towards the end of the start-up phase, however, the air intake regulation blades of the compressor are opened to their maximum value, changing in about 5 seconds from an angle of 35° to 54° with respect to the vertical plane. Depending on the ambient temperature, this opening may commence between 75 and 85% of the full speed. The pressure of the atomization air circuit may then increase, and the fuel oil which has built up in the circuit may be sent suddenly to the combustion system. The monitoring device then triggers shutdown of the turbine, by detecting an excessive speed of the rotor and an excessive temperature of the exhaust gases, that is to say a critical increase in the temperature of the exhaust gases.

Damage to the turbine is therefore unavoidable, because its shutdown occurs after significant uncontrolled introduction of fuel, which involves increased maintenance costs due to the excessive temperature and the excessive speed.

It is currently possible to detect the consequences of a fuel oil leak in a turbine, such as an abnormal fuel oil flow rate, a decrease in the acceleration of the rotor of the turbine, a drop in the temperature at the exhaust, and opening of the air intake regulation blades at the entry of the compressor. To this end, a device for monitoring the operating parameters of the gas turbine is used, such as the one developed by General Electric, the brand name of which is SPEEDTRONIC™.

Although this device is very effective for shutting the turbine down in the event of excessive speed or excessive temperature, there are still risks of damage to the turbine.

It is therefore an object of the invention to overcome the aforementioned drawbacks by providing a method of rapidly and reliably identifying a leak of fuel oil to another circuit of the turbine, in particular to the atomization air circuit, which is capable of ensuring optimal start-up of the turbine and of protecting it against possible damage over time.

The invention therefore provides a method of detecting the presence of a liquid fuel leak in a gas turbine, in which:
a reference value is determined for at least a first operating parameter of the turbine,
a value of the said operating parameter is measured during a start-up phase of the turbine,
the measurement value and the reference value are compared,
whether a first anomaly is present is identified,
an alert notification is generated if a first anomaly is detected for the first parameter, and
shutdown of the turbine is triggered if at least a second anomaly is detected.

For example, the measurement step for the said operating parameter is carried out during the start-up phase, that is to say between shutting down the activating system of the turbine and obtaining the full speed no load and/or obtaining at least one combustion flame.

In one embodiment,
a value of a second operating parameter is measured during the start-up phase,
the measured value and a reference value are compared,
whether a second anomaly is present is identified,
shutdown of the turbine is triggered if a second anomaly is present.

It is furthermore possible to carry out a third measurement of an operating parameter, compare the measured value and the corresponding reference, maximum value and, over a given period, identify whether a third anomaly is present and trigger shutdown of the turbine if a third anomaly is detected.

A check may be made that the rotation speed of the turbine is less than 90% of the full speed of the turbine.

The method may thus include at least three parallel detections, one of which can trigger an alarm and the others shutdown of the machine.

Advantageously, the operating parameters may comprise the liquid fuel flow rate and/or the acceleration of the rotation speed of the turbine and/or the opening of intake air valves at the entry of the compressor and the rotation speed of the turbine.

Tests and observations have shown that a leak lasting about 90 seconds is equivalent for sending some 80 litres of fuel oil to the atomization air circuit. On the other hand, decreasing the leakage volume by one quarter eliminates the risk of excessive speed during opening of the valves at the end of the start-up phase. The maximum period for identifying a leak may thus be of the order of 15 seconds. The monitoring device, however, acts immediately when it detects a fuel oil leak for a maximum period of 15 seconds.

On the other hand, the decrease in the acceleration is measured in shorter periods of time because of the rotational inertia of the turbine, which continues to accelerate after a decrease in the fuel oil flow rate. This is why the calculation of the acceleration gradient is carried out here for a period of 5 seconds.

Furthermore, it is important to detect an abnormally high or maximum fuel oil flow rate during the start-up phase and before complete opening of the air intake blades of the compressor, because at this moment the pressure on the atomization air circuit increases and the fuel oil present in the circuit may suddenly be sent to the combustion chamber, causing the excessive speed and degradation of the machine.

Before measuring the value of the said operating and comparing the said parameter with the reference value, a check is made that the rotation speed of the turbine is less than a predetermined percentage of the maximum speed of the turbine and that the blades are being opened.

If the condition relating to the rotation speed of the turbine, for example less than 90% of the full speed, and the condition relating to the start of opening of the blades are satisfactory, the fuel oil flow rate is measured for a predetermined duration, for example 5 seconds, and a corresponding reference value is determined.

If the measured value is equal to the reference value for the predetermined duration, an anomaly is detected and the turbine is shut down.

If the conditions relating to the speed of the turbine and the opening of the blades are not satisfactory, if the operating parameter is the liquid fuel flow rate, its value is measured during the start-up phase of the turbine, and if the measured value is greater than the reference value for a predetermined duration, for example at least 15 seconds, an anomaly is detected and the turbine is shut down.

It will be noted that the reference value of the fuel oil flow rate is the maximum value of the fuel flow rate, calculated as a function of the type of fuel oil and the flow rate necessary to reach the speed for coupling the turbine to the alternator (“Full speed no load”).

Furthermore, if the operating parameter is the acceleration of the turbine, its reference value is determined, its value is measured at each 5 second interval during the start-up phase, the reference value and the measured value are compared, and if the measured value is less than a predetermined percentage of the reference value, revealing for example that the increase of the first anomaly can be detected, an alert notification is generated.

According to another exemplary embodiment of the invention, if the operating parameter comprises the speed of the rotor or the fuel oil flow rate, its reference value is determined, its value is measured, for example from 90% of the full speed of the turbine during start-up.

If the measured value is greater than the reference value for at least 5 seconds, an anomaly is identified and the turbine is shut down.

Advantageously, after triggering shutdown of the turbine, a step of purging the ejection duct for the liquid fuel may be carried out for at least 5 minutes. The turbine may then be started 5 seconds after its shutdown, that is to say after the loss of the flame.

The invention also relates to a device for detecting a liquid fuel leak in a gas turbine by employing a method as defined above.

The present invention will be understood more clearly on reading the following description of some embodiments, which are given by way of nonlimiting examples and illustrated in the appended drawings:

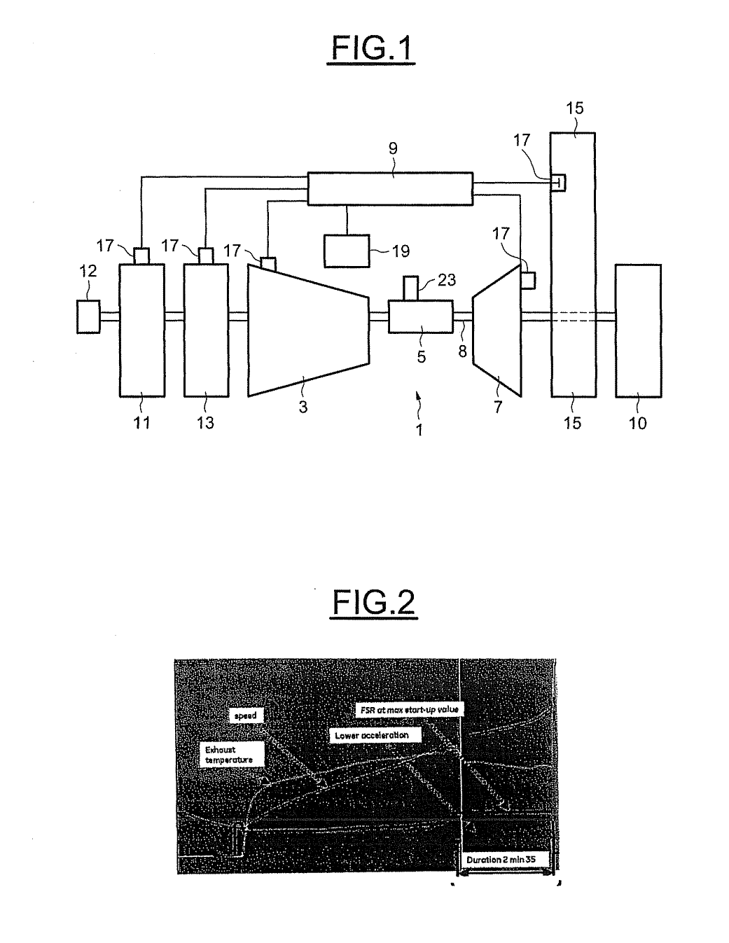

FIG. 1 is a diagram of a gas turbine equipped with an injector and circuits for conveying fuel oil and atomization air, which may experience leaks;

FIG. 2 is a graph representing the change in the various operating parameters of the turbine during a fuel oil leak;

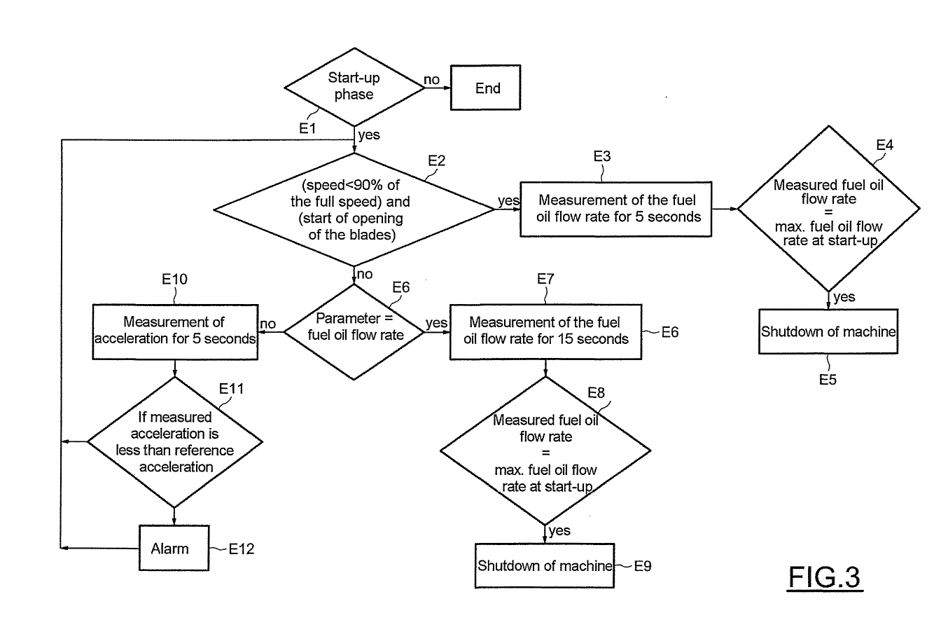

FIG. 3 is a flow chart illustrating the operation of the leak detection method according to the invention.

A gas turbine 1 will first be described with reference to FIG. 1.

As can be seen, a gas turbine 1 comprises a compressor 3, a combustion chamber 5 and a turbine 7 coupled to the compressor 3.

During operation, air enters via a duct 11 through the air intake blades 13 of the compressor 3. The hot gases expand by passing through the turbine 7, where the heat energy of the hot gases is converted into mechanical energy. An ejection duct 15 for these gases coming from the combustion chamber is provided on the turbine 7.

The rotational movement of the turbine 7 is imparted to a shaft 8, which actuates on the one hand the compressor 3 and on the other hand a load, which is specifically a receiver apparatus 10 such as a pump, an alternator, etc., coupled to its right-hand end.

In order to set the gas turbine in operation, an activating motor 12 is used which fulfils the function of a starter. Regulation of the power and the rotation speed is possible by altering the flow rate of the air at the entry of the compressor and the injection of the fuel.

The compressor 3 comprises one or more successive rings comprising fixed blades (not shown) arranged to straighten the flow of gas. Wheels comprising mobile blades (not shown) are intended to extend between these rings. Each pair consisting of a wheel comprising mobile blades and a ring comprising fixed blades forms a stage of the compressor. The wheels comprising mobile blades compress the gas by activation of the air intake blades, and each ring comprising fixed blades straightens the flow of gas coming from the wheel before it.

Some gas, or an atomized liquid fuel according to the operating mode envisaged here, is injected into the combustion chamber 5 by means of an injector 23 and ignites in the chamber 5 while mixing with the air compressed by the compressor 3.

In order to atomize the liquid fuel, in this case the fuel oil, an atomization gas such as air is injected so as to destabilize the flow of fuel and form a spray of fuel having an increased contact surface with the oxidant, with a view to promoting the combustion. For this purpose, the injector 23 comprises a liquid fuel oil ejection duct and a compressed air ejection duct (neither of which is shown), the fuel oil jet flowing at a relatively low speed and being destabilized by a flow of compressed air at high speed.

Operation of the gas turbine 1 is monitored by various sensors 17 detecting its operating conditions. For example, temperature sensors detect the temperature of the exhaust gases at the exit of the turbine and other temperatures coming from the turbine. Pressure sensors may monitor the ambient pressure, the static and dynamic pressures at the entry and the exit of the compressor, as well as the pressure at other points of the gas flow taking place in the turbine 1. The sensors 17 may also comprise humidity sensors, flow sensors for the gas, speed sensors for the rotor of the turbine, sensors for detecting flames in the combustion chamber, sensors for monitoring the opening of the intake blades for the air entering the compressor, and many other sensors capable of monitoring the relevant operating parameters of the gas turbine 1. As employed above, the term “parameter” refers to the quantities which can be used to define the operating conditions of the gas turbine 1, such as the temperature, pressure, speed, opening angle of the air intake blades, the flow rate of the gas at various positions in the turbine, and which can show whether the operating status of the said gas turbine 1 is good or bad.

The sensors 17 are connected to a device 9 for monitoring the operating parameters of the gas turbine 1. This may be a device developed by General Electric, the brand name of which is SPEEDTRONIC™, such as a computer comprising a processor capable of executing a program for monitoring the operating parameters of the gas turbine 1 by using the values collected by the sensors 17 and the instructions of the human operators.

A device for monitoring the flow of the fuel oil 19 regulates its flow rate in the ejection duct until it is atomized with the aid of the compressed air ejection duct. The device for monitoring the fuel oil flow rate may be a monitoring unit independent of the device 9 for monitoring the operating parameters of the gas turbine, or it may be integrated therewith.

In order to detect a leak of fuel oil to an inappropriate duct of the gas turbine, and particularly to the atomization air duct, characteristic operating parameters of the gas turbine 1 are monitored and if need be an alert notification or even complete shutdown of the turbine 1 is triggered.

These parameters have been selected by observing the various consequences of a leak, as are illustrated in the graph of FIG. 2:
decrease in the acceleration of the gas turbine,
increase in the fuel oil flow rate in order to compensate for the decrease in acceleration,
maximum value of the fuel oil flow rate for at least 15 seconds,
opening of the air intake blades at the entry of the compressor (not shown on the graph),
increase or decrease in the temperature in the exhaust duct for the hot gases after passing through the turbine, and
excessive speed of the shaft of the turbine.

According to these observations, the monitored parameters considered to be most reliable for rapid detection of the leak are: the fuel oil flow rate, the acceleration of the shaft of the turbine 1 and the opening of the air intake blades at the entry of the compressor 3.

Considering FIG. 3, it presents a flow chart illustrating nonlimiting examples of operations carried out by the monitoring device 9 in order to detect and automatically signal a fuel oil leak in the gas turbine 1, and shut down the turbine. One advantageous aspect of the following example of a method is that the owner/operator of the gas turbine 1 is advised of the leak by an audible visual signal rapidly and automatically after the detection of the leak, and this is done reliably. Triggering shutdown of the turbine is also provided if a second operating parameter is found to be abnormal.

Thus, if only a first anomaly of the acceleration is identified, the device 9 automatically generates an alert notification. If the first anomaly of the acceleration and the second anomaly of the fuel flow rate are identified, the monitoring device 9 generates an alert notification and shutdown of the turbine during the step.

If shutdown of the gas turbine is triggered, a purge of the fuel oil circuit is carried out for at least 5 min, at most 5 seconds after loss of the flame in the combustion chamber 5. The purpose of this purging is to make it possible to remove the fuel oil in order to avoid coking of the fuel oil, as well as to cool the injectors close to the combustion chamber. It should be pointed out that the measurements of the parameters are carried out only if the speed allows autonomous rotation of the turbine, and at least one combustion flame is detected in the combustion chamber 5.

Thus, according to the invention, parallel monitoring of various operating parameters of the turbine is carried out.

If a first anomaly is present concerning a first operating parameter, for example the acceleration, an alert notification is generated.

On the other hand, if an anomaly is detected concerning at least a second operating parameter, the turbine is shut down.

For example, in various embodiments an alert notification may be generated if the monitoring of the acceleration of the turbine reveals an anomaly, and the turbine is shut down if the monitoring of the opening of the intake valves of the compressor or the fuel flow rate reveals an anomaly.

As shown in FIG. 3, during a first step E1, the detection of a start-up phase is carried out, that is to say between decoupling of the activating system and the end of the start-up phase, i.e. when a combustion flame is detected. If such is the case, during the next step E2, whether the rotation speed of the turbines is less than 90% of the full speed of the turbines is detected and also whether the opening of the air intake blades has started, that is to say if the angle of the opening of the blades has reached 35°.

If such is the case, if these two conditions are satisfied, for example, during the next step E3 measurement of the fuel oil flow rate is carried out for a predetermined duration, here five seconds.

The device 9 also determines the reference value for the fuel oil flow rate. This value is determined by assuming that it is the maximum value of the fuel oil flow rate permissible for operation of the turbine.

If the measured fuel oil flow rate is greater than or equal to the maximum fuel oil flow rate at start-up for this duration of five seconds (step E4), the machine is shut down (step E5).

If one of the two conditions checked during the preceding step E2 is not satisfied, the parameter being checked is monitored during the next step E6. In particular, whether the monitoring parameter is the fuel oil flow rate is detected.

If such is the case, the fuel oil flow rate (step E7) is measured for a predetermined duration, here fifteen seconds, then a check is made whether the measured fuel flow rate is greater than or equal to the maximum fuel flow rate at start-up for this duration of 15 seconds (step E8). If such is the case, the machine is then shut down (step E9).

In parallel, if during the preceding step E6 it was determined that the monitoring parameter is not the fuel oil flow rate, during the next step E10 the acceleration of the rotor of the turbine is measured, and this is done for five seconds (step E10). Furthermore, the device determines the reference value for the acceleration of the rotor of the turbine. This value is determined by calculating the speed of the rotor at shutdown then 5 seconds after its activation, the difference between the two speed values being taken as a reference for the acceleration.

If, during the next step E11, it is detected that the measured acceleration is less than the reference acceleration, an alarm is generated (step E12).

For example, the reference value and the measured value are compared and if the measured acceleration is less than or equal to 0.08% of the reference acceleration, or in other words if the increase in the speed is less than 0.08% of the reference to speed increase, an alarm is generated because the acceleration is too slow. If no anomaly is detected, the method returns to the preceding step E2.

According to the invention, the monitoring device 9 will carry out the leak detection method as described above. It may then be in the form of:
a computer program code containing executed instructions on physical media such as floppy disks, CD-ROMs, hard disks or any other storage medium readable by the device 9, in which case, when the computer program code is loaded in or executed by the monitoring device 9, it becomes capable of applying the detection method according to the invention,
a computer program code, whether stored in a storage medium, loaded and/or executed by a computer or transmitted by using a transmission means, in particular by wires or electrical cables, via optical fibres or by electromagnetic radiation, in which case, when the computer program code is loaded in and/or executed by the monitoring device 9, it becomes capable of applying the detection method according to the invention,
a computer program code configuring a universal microprocessor in order to create specific logic circuits (that is to say a set of programmed logic circuits), in which case, when the computer program code is loaded in and/or executed by the monitoring device 9, it becomes capable of applying the detection method according to the invention.

The program executed by the monitoring device 9 may also comprise algorithms parameterized over time in order to regulate the flow of fuel oil into the combustion chamber 5.

By virtue of the invention, a simple and reliable automatic device is provided for monitoring the operating parameters and signalling anomalies present in the gas turbine. The device indicates the presence of a fuel oil leak to an inappropriate duct of the turbine, for example to the atomization air duct of the injector, and provides an alert notification of the leak as early as possible to an owner or operator of a gas turbine so as to facilitate planning and performance of maintenance interventions as far upstream as possible. It may also, depending on the case, trigger a shutdown of the turbine and automatic purging of it in order to protect the said turbine from any damage which the leak could cause. According to the invention, the order in which the anomalies are detected is arbitrary, and many other exemplary embodiments of the method could be described without departing from the scope of the invention.

1. Method of detecting the presence of a liquid fuel leak in a gas turbine (1), characterized in that:
a reference value is determined for at least a first operating parameter of the turbine,
a value of the said operating parameter is measured during a start-up phase of the turbine,
the measurement value and the reference value are compared,
whether a first anomaly is present is identified,
an alert notification is generated if a first anomaly is detected for the first parameter, and
shutdown of the turbine is triggered if a second anomaly is detected for a second parameter.

2. Method according to claim 1, characterized in that the measurement step for the said operating parameter is carried out during the start-up phase between shutdown of the activating system of the turbine and detection of at least one combustion flame.

3. Method according to one of claims 1 and 2, characterized in that a value of a second operating parameter is measured during the start-up phase, the measured value and a reference value are compared, whether an anomaly is present is identified and shutdown of the turbine is triggered if a second anomaly is detected, a value of a third operating parameter is measured during the start-up phase, the measured value of the third operating parameter is compared with a reference value, whether an anomaly is present is identified and shutdown of the turbine is triggered if a third anomaly is detected.

4. Method according to one of claims 1 to 3, characterized in that the operating parameters comprise the liquid fuel flow rate and/or the acceleration of the rotation speed of the turbine and/or the opening of intake air valves of the compressor and the rotation speed of the turbine.

5. Method according to any one of claims 1 to 4, characterized in that before measuring the value of the said parameter and comparing the said parameter with the reference value, a check is made that the rotation speed of the turbine is less than a predetermined percentage of the full speed of the turbine and that the blades are being opened.

6. Method according to claim 5, characterized in that a check is made that the rotation speed of the turbine is less than 90% of the full speed of the turbine.

7. Method according to one of them claims 5 and 6, in which, if the condition relating to the rotation speed of the turbine being less than a predetermined percentage of the full speed of the turbine, and the condition relating to the opening rate of the blades are satisfactory, the flow rate is measured for a predetermined duration, for example 5 seconds, and a corresponding reference value is determined for the flow rate and, if the measured value is equal to the reference value for the said determined duration, an anomaly is detected and the turbine is shut down.

8. Method according to any one of claims 1 to 7, characterized in that, the operating parameter being the liquid fuel flow rate, its reference value (37) is determined, its value (39) is measured during the start-up phase of the turbine, the reference value and the measured value are compared, and if the measured value is greater than the reference value for a predetermined duration, for example at least 15 seconds, an anomaly is detected and the turbine is shut down.

9. Method according to claim 8, characterized in that the reference value (27) is the maximum value of the liquid fuel flow rate which is permissible during start-up of the turbine.

10. Method according to any one of the preceding claims, characterized in that, the operating parameters being the acceleration of the turbine, its reference value (27) is determined, its value (29) is measured during the start-up of the turbine, the reference value and the measured value are compared, and if the measured value is less than a predetermined percentage of the reference value, a first anomaly (31) is identified and an alert notification (33) is generated.

11. Method according to any one of claims 4 to 10, characterized in that if, simultaneously with a first acceleration anomaly, the measured value (39) of the liquid fuel flow rate is greater than its reference value (37) for at least 15 seconds, a second anomaly (44) is identified and shutdown of the turbine (45) is triggered.

12. Method according to any one of the preceding claims, characterized in that after triggering shutdown of the turbine, a step of purging the ejection duct for the liquid fuel is carried out for at least 5 minutes, at most 5 seconds after the loss of the flame.

13. Device for detecting a liquid fuel leak in a gas turbine (1), the turbine comprising a device (9) for monitoring the operating parameters of the turbine and a storage medium readable by a computer, in which computer program instructions executable by the said device (9) are stored, the instructions of the computer program making the parameter monitoring device (9):
determine a reference value for a first operating parameter of the turbine,
measure a value for the same operating parameter after start-up of the turbine,
compare the reference and measured values,
identify whether a first anomaly is present according to predetermined characteristics,
generate an alert notification if a first anomaly is detected for a first parameter, and in parallel
trigger shutdown of the turbine if a second anomaly is detected for a second parameter.
